(19) United States
(12) Patent Application Publication
(10) Pub. No.: US 2018/0122535 A1
(43) Pub. Date: May 3, 2018

(54) METHOD FOR MANUFACTURING WIRE HARNESS AND IMAGE PROCESSING METHOD

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Xiaoming NIU, Kusatsu-shi, Shiga-ken (JP); Gang XU, Kusatsu-shi, Shiga-ken (JP); Tomohiro NAKAMICHI, Kusatsu-shi, Shiga-ken (JP); Satoshi OE, Yokkaichi, Mie (JP); Shigeto KATO, Yokkaichi, Mie (JP)

(21) Appl. No.: 15/563,306

(22) PCT Filed: Mar. 24, 2016
(86) PCT No.: PCT/JP2016/059280

§ 371 Date: Sep. 29, 2017

(30) Foreign Application Priority Data
Mar. 31, 2015 (JP) 2015-072548

(51) Int. Cl. H01B 13/012; G01B 11/26

(52) U.S. Cl. CPC H01B 13/01209; G06T 2207/10028; H01B 13/01263; G01B 11/26

(57) ABSTRACT

A technique suitable for measuring the shape of a linear object. In the process of manufacturing a wire harness, a processing position identification process, in which a processing position is identified by measuring the three-dimensional shape of a wire assembly, is executed. This processing position identification process includes the following: a point group data acquisition step of acquiring point group data from image data acquired by capturing an image of the wire assembly using an image capturing unit; a representative line acquisition step of acquiring a representative line indicating a linear part of the wire assembly on the basis of the point group data; and a processing position identification step of identifying the processing position on the wire assembly to be processed, on the basis of a length along the representative line.

### CROSS REFERENCE TO RELATED APPLICATIONS

This application claims the priority of Japanese patent application JP2015-072548 filed on Mar. 31, 2015, the entire contents of which are incorporated herein.

### TECHNICAL FIELD

This invention relates to a technique for measuring the three-dimensional shape of a wire harness.

### BACKGROUND ART

Recently, attempts are being made to automate the manufacture of wire harnesses. In the automation of wire harness manufacturing, identifying a position of a flexible linear object to be processed is an extremely important issue.

For example, in Patent Document 1 (JP-2009-069866A), a laser beam emitted from a laser emitter is transformed into patterned light having a plurality of slit-shaped beams, and a plurality of bright points produced when the slit-shaped beams strike a cable are extracted as feature points.

Meanwhile, in Patent Document 2 (JP-2013-109691A), an original image acquired by capturing an image of a workpiece is binarized and the edges thereof are extracted. The binarized image is subjected to an expanding process, and a plurality of reference points are set on a boundary line corresponding to the workpiece in the expanded region. The edges are at a minimum distance are specified for all of the reference points, and a contour line of the original workpiece is extracted by connecting those edges.

### SUMMARY

However, in the case of the technique disclosed in Patent Document 1, the positions of the bright points will change when the cable is moved. This technique is thus not suited to measuring a shape when processing a flexible object. In the case of the technique disclosed in Patent Document 2, it is necessary to process the data of many points in order to extract and verify the edges, and thus the computational processing has taken time.

In particular, when automating the bundling and shaping of a plurality of wires, it is necessary to measure lengths between the positions of each part of a linear object or lengths between specific areas, and there has been demand for a shape measurement technique suited to such a process.

Accordingly, an object of the present application is to provide a technique suitable for measuring the shape of a linear object.

To solve the aforementioned problems, a first aspect is a method of manufacturing a wire harness, the method including: a point group data acquisition step of acquiring point group data from image data acquired by capturing an image of a wire assembly using an image capturing unit; a representative line acquisition step of acquiring a representative line indicating a linear part of the wire assembly on the basis of the point group data; and a processing position identification step of identifying a processing position on the wire assembly to be processed, on the basis of a length along the representative line.

A second aspect is the method of manufacturing a wire harness according to the first aspect, wherein the processing position identification step includes a step of identifying a branch point where the representative line branches, and identifying the processing position on the basis of a length from the identified branch point along the representative line.

A third aspect is the method of manufacturing a wire harness according to the second aspect, further including an orientation identification step of acquiring, for two of the branch points connected by a representative line part that is a part of the representative line, two virtual planes formed by a plurality of representative line parts extending from the two branch points, and identifying an orientation of a member to be attached to the representative line connecting the two branch points on the basis of an angle formed by the two virtual planes.

A fourth aspect is the method of manufacturing a wire harness according to any one of the first to third aspects, wherein the representative line acquisition step is a step of identifying a group of center points of a linear part of the wire assembly on the basis of the point group data and using a line connecting that group of center points as the representative line.

A fifth aspect is the method of manufacturing a wire harness according to the fourth aspect, wherein the group of center points is a collection of center points, of a point group located on a contour of the wire assembly expressed by the point group data, that are in the center with respect to two directions orthogonal to a depth direction.

A sixth aspect is the method of manufacturing a wire harness according to any one of the first to fifth aspects, further including a background removal step of removing, from the point group data acquired in the point group data acquisition step, background point group data obtained by capturing an image of a background without the wire assembly using the image capturing unit, wherein the representative line acquisition step is a step of acquiring the representative line on the basis of point group data from which the background point group data has been removed.

A seventh aspect is the method of manufacturing a wire harness according to any one of the first to sixth aspects, further including a hidden line acquisition step of connecting two end parts, among end parts of the representative line acquired in the representative line acquisition step, that are within a predetermined distance.

An eighth aspect is the method of manufacturing a wire harness according to any one of the first to seventh aspects, wherein the image capturing unit detects phase differences between laser light emitted onto points of the wire assembly and laser light reflected by those respective points using a plurality of two-dimensional detectors.

A ninth aspect is an image processing method including: a point group data acquisition step of acquiring point group data from image data acquired by capturing an image of a wire assembly using an image capturing unit; a representative line acquisition step of acquiring a representative line indicating the wire assembly on the basis of the point group data; and a processing position identification step of identifying a processing position on the wire assembly to be processed, on the basis of a length along the representative line.

According to the first aspect, three-dimensional shape of the wire assembly can be measured with ease, and the processing position can be identified with a high level of precision, by extracting the representative line expressing a linear part of the wire assembly.

According to the second aspect, the processing position can be identified on the basis of the length from the branch point.

According to the third aspect, twisting in a wire assembly part connecting two branch points can be identified from the angle formed by the virtual planes at the two branch points. An attachment orientation when attaching a member can thus be appropriately identified in accordance with that twisting.

According to the fourth aspect, the three-dimensional shape of the linear part of the wire assembly can be identified with a high level of precision by identifying the group of center points of the wire assembly in the point group data and taking a line connecting those center points as the representative line. As a result, the processing position can be identified with a high level of precision.

According to the fifth aspect, a center line of the linear part of the wire assembly can be acquired in a precise manner.

According to the sixth aspect, the amount of computational processing can be reduced by removing the background point group data from the point group data.

According to the seventh aspect, even if the linear part of the wire assembly is hidden by another member or the like and the representative line is broken as a result, the representative line can be connected. Accordingly, the hidden line can be virtualized in order to favorably identify the shape of the wire assembly.

According to the eighth aspect, the positions of each of points on the wire assembly can be identified with a high level of precision. Accordingly, the shape of the wire assembly can be identified with a high level of precision.

### BRIEF DESCRIPTION OF DRAWINGS

FIG. 1 is a schematic perspective view of a measurement apparatus according to an embodiment.

FIG. 2 is a block diagram illustrating the hardware configuration of an image processing apparatus according to an embodiment.

FIG. 3 is a block diagram illustrating the software configuration of an image processing apparatus according to an embodiment.

FIG. 4 is a flowchart illustrating a processing position identification process carried out in the course of manufacturing a wire harness.

FIG. 5 is a diagram illustrating a processing position identification process.

FIG. 6 is a diagram illustrating a representative line acquisition step.

FIG. 7 is a diagram illustrating a hidden line acquisition step.

FIG. 8 is a diagram illustrating an orientation identification step.

### DESCRIPTION OF EMBODIMENTS

An embodiment of the present application will be described hereinafter with reference to the appended drawings. Note that the constituent elements described in this embodiment are merely examples, and the scope of the present invention is not intended to be limited only thereto. Furthermore, the dimensions, numbers, and so on of the elements may be exaggerated or simplified in the drawings as necessary to facilitate understanding.

### 1. Embodiment

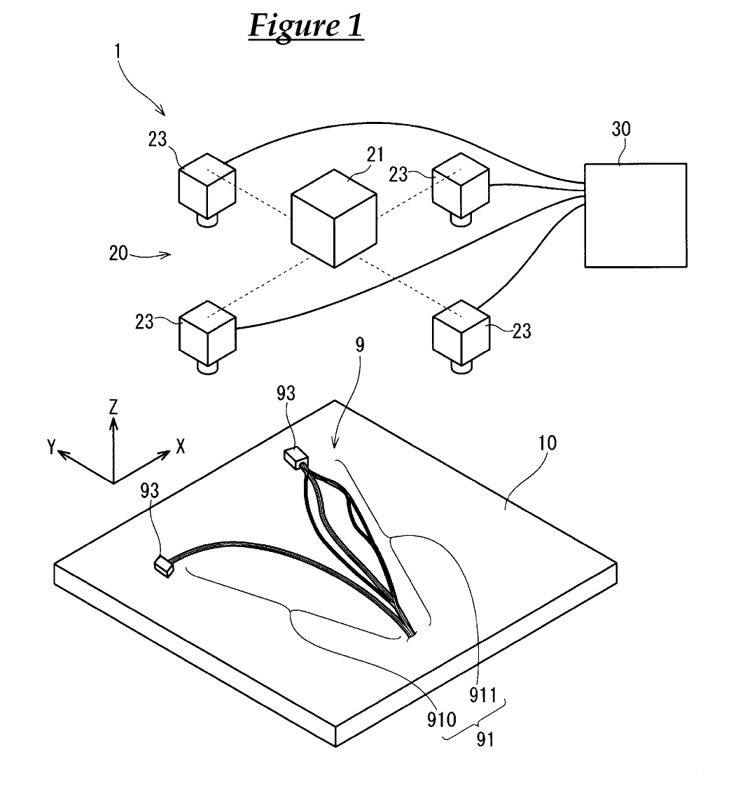

FIG. 1 is a schematic perspective view of a measurement apparatus 1 according to an embodiment. The measurement apparatus 1 is configured as an apparatus that measures the three-dimensional shape of a wire assembly 9, and includes a stage 10, an image capturing unit 20, and an image processing apparatus 30.

The wire assembly 9, which is to be measured by the measurement apparatus 1, includes a linear part 91 constituted of a plurality of wires, connectors 93 to which the terminal parts of a plurality of wire groups are connected, and so on. The linear part 91 may have branches. The linear part 91 may also include parts aside from wires (fiber-optic cables, for example). A wire harness is manufactured by carrying out processes such as tying the wire assembly 9 to a predetermined processing position, attaching various types of members, and so on. For example, as illustrated in FIG. 1, the linear part 91 of the wire assembly 9 may include a bundled part 910 in which a plurality of wires are wrapped in tape or the like in advance to produce a single bundle, and a loose wire part 911 that is a part in which a plurality of wires are loose.

The stage 10 is provided for placing the wire assembly 9, which is a measurement target. Note that the vicinity of the connectors 93 of the wire assembly 9 may be held such that the linear part 91 hangs down, for example, rather than providing the stage 10.

The image capturing unit 20 includes a laser beam emission unit 21 and a plurality of (four, in this case) cameras 23. Each of the plurality of cameras 23 includes a two-dimensional detector that detects reflected light produced when a laser beam emitted from the laser beam emission unit 21 is reflected by the wire assembly 9.

In the following descriptions, a direction perpendicular to image capturing planes of the plurality of cameras 23 (detection surfaces of the two-dimensional detectors) will be called a “depth direction”, and an axis parallel to that depth direction will be called a “Z axis”. Axes in two directions that are parallel to a two-dimensional plane perpendicular to the depth direction and that are orthogonal to each other will be called an “X axis” and a “Y axis”.

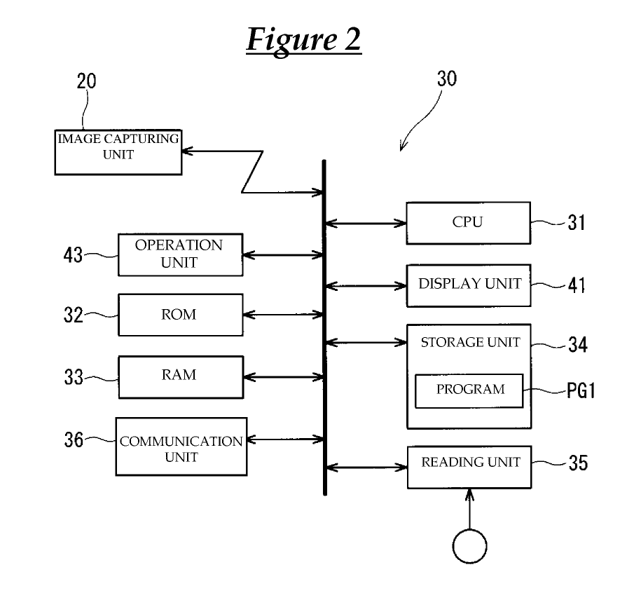

FIG. 2 is a block diagram illustrating the hardware configuration of the image processing apparatus 30 according to an embodiment. The image processing apparatus 30 includes a CPU 31 serving as a control unit, ROM 32 that is read-only and that stores basic programs and the like, RAM 33 used primarily as a working area for the CPU 31, and a storage unit 34 that is a non-volatile recording medium. Thus the image processing apparatus 30 is configured as a typical computer.

A program PG1 is stored in the storage unit 34. Various functions are realized by the CPU 31, serving as a main control unit, carrying out computational processes in accordance with the program PG1. The program PG1 may normally be stored in advance in memory such as the storage unit 34, but may instead be provided having been recorded in a CD-ROM, a DVD-ROM, or a flash memory (that is, as a program product) read from that recording medium by a reading unit 35, and loaded into the image processing apparatus 30. Alternatively, the program PG1 held on a network may be loaded into the image processing apparatus 30 via a communication unit 36. Other data may also be loaded into the image processing apparatus 30 via the reading unit 35 or the communication unit 36.

Meanwhile, the image processing apparatus 30 is connected to the image capturing unit 20, a display unit 41, and an operation unit 43 by a bus line, a network line, or a serial line. The display unit 41 is a device that displays an image, such as a liquid crystal display. The operation unit 43 is an input device constituted of a keyboard, a mouse, or switches, for example, and accepts various types of operations from an operator. The operation unit 43 may be configured as a touch panel or the like. In this case, the touch panel may also function as the display unit 41.

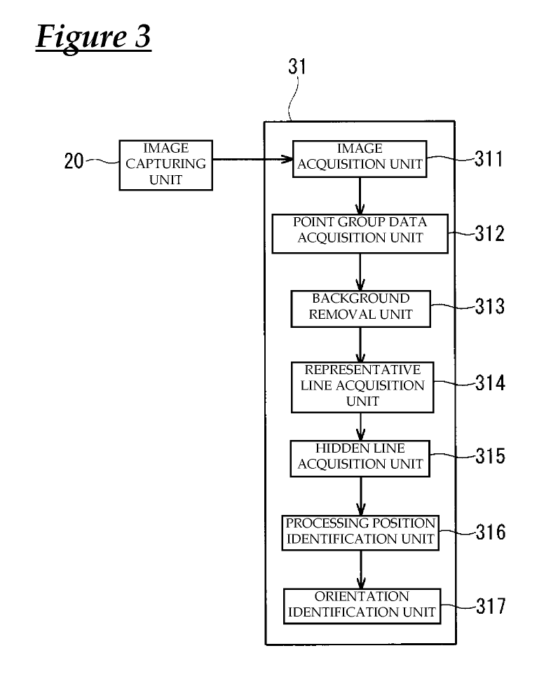

FIG. 3 is a block diagram illustrating the software configuration of the image processing apparatus 30 according to the embodiment. As illustrated in FIG. 3, the CPU 31 of the image processing apparatus 30 functions as an image acquisition unit 311, a point group data acquisition unit 312, a background removal unit 313, a representative line acquisition unit 314, a hidden line acquisition unit 315, a processing position identification unit 316, and an orientation identification unit 317. Note that some or all of these functions may be realized as hardware by dedicated circuits or the like.

The image acquisition unit 311 processes each of signals sent from the plurality of cameras 23 in the image capturing unit 20 that have captured an image of the wire assembly 9, and acquires a plurality of pieces of image data. The plurality of pieces of image data may instead be acquired by another computer or the like processing the data acquired by the image capturing performed by the image capturing unit 20. In this case, the plurality of pieces of image data may be loaded into the image processing apparatus 30 from the exterior via the above-described reading unit 35 or communication unit 36.

The point group data acquisition unit 312 processes the plurality of pieces of image data acquired from the image acquisition unit 311 and acquires three-dimensional reflection point group data (called simply “point group data” hereinafter). In the present embodiment, laser beams reflected by each of parts of the wire assembly 9 (reflected light) are incident on respective points of the two-dimensional detectors of the plurality of cameras 23, and from the positions of these points, three-dimensional position information is acquired from the points on the wire assembly 9 that reflects the reflected light. The three-dimensional position information at each point on the wire assembly 9 is acquired by measuring a distance between a detection position of each of the cameras 23 and each point on the wire assembly 9, on the basis of a phase difference between the emitted light and the reflected light. The point group data acquisition unit 312 acquires point group data pertaining to the wire assembly 9 on the basis of this three-dimensional position information.

The image capturing unit 20 is not limited to the above-described configuration, and any configuration may be employed as long as three-dimensional information of the wire assembly can be acquired. Note that it is not necessary to acquire information such as the phase difference in order to acquire the point group data. However, acquiring the phase difference information makes it possible to accurately acquire the three-dimensional position information at each point on the surface of the wire assembly 9. The image capturing unit 20 may instead be constituted of a single light source and a single camera. In this case, the three-dimensional position information at each point on the surface of the wire assembly 9 can be acquired from the emission direction of the laser beam and the position of incidence on the detector of the camera.

The background removal unit 313 removes, from the point group data acquired by the point group data acquisition unit 312, only the point group data in a background excluding the wire assembly 9 (here, the “background” corresponds to the surface of the stage 10 of the measurement apparatus 1). The point group data of only the background is acquired by carrying out image processing on the image data of only the background, acquired by using the image capturing unit 20 to capture an image of the stage 10 without the wire assembly 9. The point group data of only the background may, for example, be acquired in advance and stored in the storage unit 34 or the like. The process for removing the point group data of the background can be realized, for example, by finding an XOR (exclusive OR) between the point group data containing the wire assembly 9 and the point group data of only the background. Note that in the following descriptions, the point group data from which the point group data of only the background has been removed is called “point group data of the wire assembly 9”.

The representative line acquisition unit 314 acquires representative lines indicating the wire assembly 9 from the point group data of the wire assembly 9. Each representative line is acquired by replacing the linear part 91 of the wire assembly 9 with a single virtual line in accordance with the three-dimensional shape.

The hidden line acquisition unit 315 supplements a missing part of the representative line by connecting two end parts, of the respective end parts of the representative line acquired by the representative line acquisition unit 314, that are within a predetermined distance. As one example, the hidden line acquisition unit 315 extends the representative line from the two end parts in the direction that connects those two end parts. Thus even if the linear part 91 of the wire assembly 9 is hidden by another member or the like and a linear part not detected as the representative line (a hidden line) arises as a result, that hidden line can be supplemented. Supplementing a hidden line in this manner makes it possible to identify the shape of the wire assembly 9 by assuming the hidden line in the linear part 91, and thus the processing position can be identified favorably.

The configuration is such that in the case where the loose wire part 911 is present in the linear part 91 of the wire assembly 9 as illustrated in FIG. 1, the representative line acquisition unit 314 acquires one representative line from each of the wires present in the loose wire part 911. A method of acquiring one representative line from the loose wire part 911 will be described later.

Once the representative lines representing the wire assembly 9 have been acquired by the representative line acquisition unit 314 and the hidden line acquisition unit 315, the loose wire part 911 in the wire assembly 9 is bundled together along the representative line. In the following descriptions, a wire assembly 9 in which the loose wire part 911 is bundled together will also be called a “wire bundle”.

The processing position identification unit 316 identifies a processing position, which is a position of the wire bundle to be processed, on the basis of a length along the representative line. The processing position identification unit 316 takes end parts of the representative lines indicating the linear part 91 of the wire bundle (for example, points of merger with the connectors 93 line, as branch points). The processing position identification unit 316 identifies the processing position by measuring a distance along the representative lines from the identified branch points.

The orientation identification unit 317 identifies an orientation at which a member is to be attached at the processing position identified by the processing position identification unit 316. For example, with a clamp or the like for fixing a wire harness to the body of a vehicle, the orientation of a locking part of the clamp when attached to the wire harness is determined in advance. Accordingly, in the case where the clamp is attached to the wire bundle, it is necessary to identify the orientation of the clamp with respect to the wire bundle. When a member is to be attached to the processing position, the orientation identification unit 317 identifies the orientation of that member.

Specifically, of the branch points identified by the processing position identification unit 316, the orientation identification unit 317 acquires, for each of two branch points connected by the representative line, a virtual plane formed by a plurality of representative lines extending from each of the branch points, and then acquires an angle formed by those two virtual planes. The angle formed by these two virtual planes indicates how twisted the linear part 91 of the wire bundle indicated by the representative lines connected to the two branch points is. The orientation to be used during attachment can be suitably determined for the linear part 91 of the wire bundle from this angle.

### <Method of Manufacturing Wire Harness>

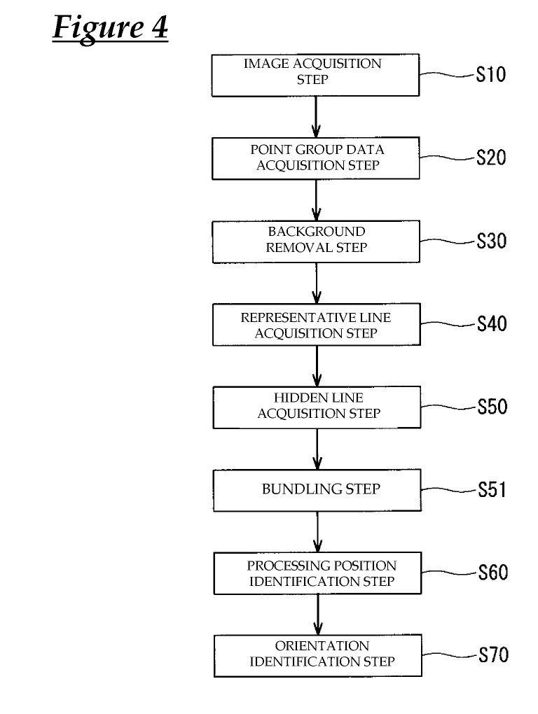

FIG. 4 is a flowchart illustrating a processing position identification process in the course of manufacturing the wire harness. First, the image acquisition unit 311 acquires the image data (an image acquisition step S10). Next, the point group data acquisition unit 312 acquires the point group data on the basis of the image data acquired in the image acquisition step S10 (a point group data acquisition step S20). Then, the background removal unit 313 removes the point group data of the background from the point group data acquired in the point group data acquisition step S20 to acquire the point group data of the wire assembly 9 (a background removal step S30).

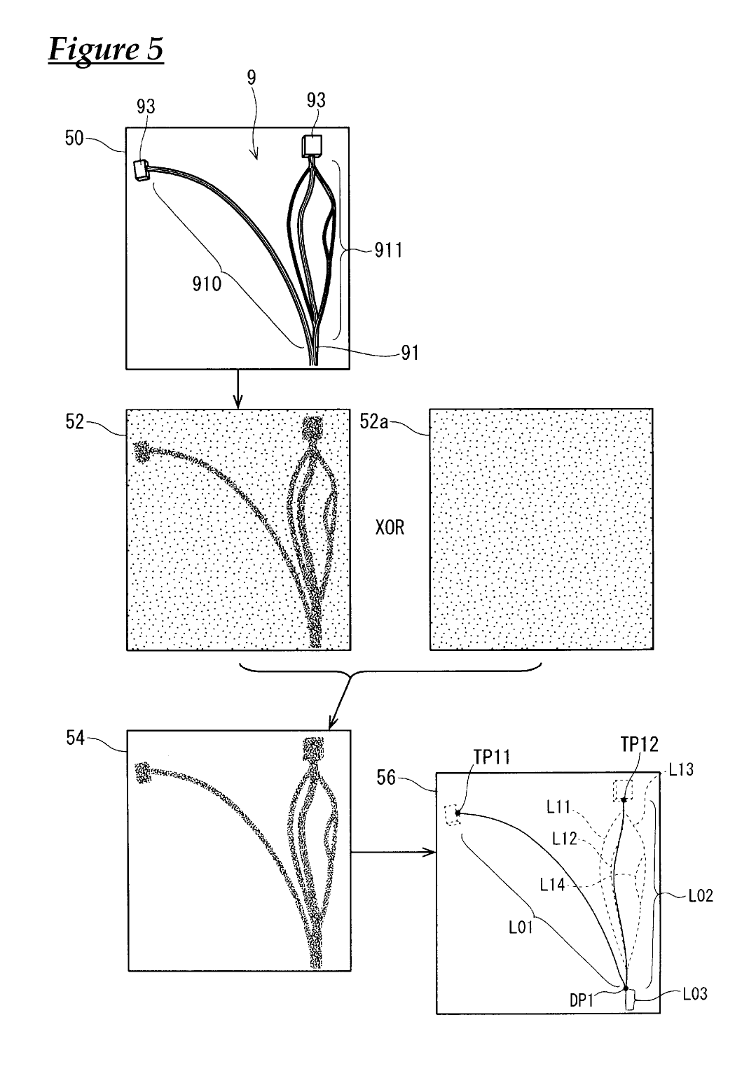

FIG. 5 is a diagram illustrating the processing position identification process. An image 50 illustrated in FIG. 5 is a visible light image captured by the cameras 23.

An image 52 is an image in which point groups expressed by the point group data have been projected onto a two-dimensional plane (an XY plane). An image 52a, meanwhile, is an image in which point groups expressed by the point group data of only the background have been projected onto the two-dimensional plane. As described above, in the background removal step S30, the point group data of the wire assembly 9, indicated in an image 54, is acquired by the background removal unit 313 taking an XOR between the point group data indicated by the image 52 and the point group data indicated by the image 52a.

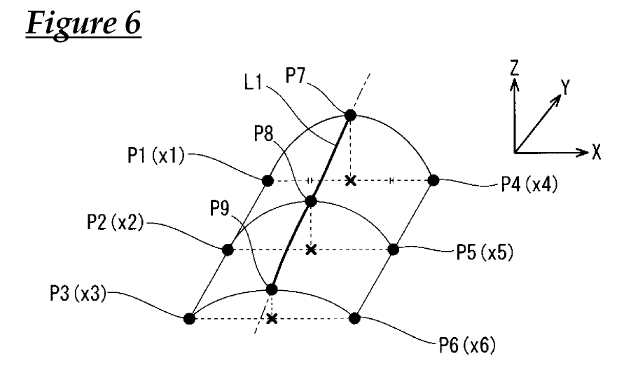

Returning to FIG. 4, the representative line acquisition unit 314 acquires the representative lines indicating the wire assembly 9 on the basis of the point group data of the wire assembly 9 acquired in the background removal step S30 (a representative line acquisition step S40). An example of the representative line acquisition step S40 will be described with reference to FIG. 6.

FIG. 6 is a diagram illustrating the representative line acquisition step S40. As illustrated schematically in FIG. 6, three-dimensional position information for each of points on the surface of the wire assembly 9 (points P1 to P9) is recorded in the point group data of the wire assembly 9. Note that the points P1 to P9 illustrated in FIG. 6 are points indicated as representatives of part of the point group on the surface of a single wire constituting the linear part 91 of the wire assembly 9. The points P1 to P3 and the points P4 to P6 correspond to respective contours when measuring the linear part 91 of the wire assembly 9.

Of the point groups of the wire assembly 9 expressing the point group data, the representative line acquisition unit 314 acquires a point group on the contours and acquires a center point of that point group on the contours. Specifically, this center point is a point in the center of the point group on the contour line, with respect to the X axis direction and the Y axis direction. The contours of the wire assembly 9 in the point group data can be identified by the position, in the depth direction, of each point group expressed by the point group data. In this case, following the point furthest on the depth side (the side on the direction moving away from the cameras 23) within a predetermined ranges of the depth direction, the positions of the point group data on the contour can be identified. Alternatively, the contours of the wire assembly 9 may be obtained from a two-dimensional image captured by the cameras 23 (for example, from the image 50) through image processing, and a point group in positions corresponding to those contours may be taken as the point group on the contours of the wire assembly 9.

For example, in the case of the example illustrated in FIG. 6, the point group on the wire assembly 9 expressed by the point group data is the points P1 to P9, and the points P1 to P6 are identified as the point group on the contours. Next, center points of the points P1 to P6 on the contours are identified, with respect to the X axis direction and the Y axis direction. Assuming the point P1 and the point P4 are arranged along the X axis direction (in other words, that the points P1 and P4 have the same Y coordinates), the center in the X axis direction is the average value of the X axis coordinates of the points P1 and P4 (represented by x1 and x4, respectively) (that is, (x1+x4)/2). Accordingly, the center point of the points P1 and P4 with respect to the X axis direction is the point P7, where the X axis coordinates correspond to (x1+x4)/2. Likewise, the center point of the points P2 and P5 is the point P8, the center point of the points P3 and P6 is the point P9. Although not illustrated in the drawing, center points can be acquired with respect to the Y axis direction in the same manner.

The point group data is only acquired for the surface of the upper half of the wire assembly 9. Accordingly, the points P7 to P9 may be used as the center points with respect to the Y axis direction. Meanwhile, the radius of that part of the wire assembly 9 may be estimated from the points arranged along the X axis direction (for example, from the points P1 and P4), and the center points may then be determined taking that part into consideration.

The representative line acquisition unit 314 acquires a line connecting the group of center points (the points P7 to P9) identified in this manner as a representative line L1. As illustrated in FIG. 5, the representative lines illustrated in an image 56 are acquired by the representative line acquisition unit 314 from the point group data of the wire assembly 9 illustrated in the image 54.

Note that the representative lines do not necessarily need to be lines connecting the center points of point groups located on the contours of the wire assembly 9, as described above. For example, a point group arranged along a contour of the wire assembly 9 may be used as a representative line. However, connecting the center points to obtain the representative lines makes it possible to acquire representative lines that resemble the center lines of the linear parts of the wire assembly 9. Thus by measuring the lengths of the representative lines, the processing positions of the linear parts of the wire assembly 9 can be identified with a high level of precision.

In the example illustrated in FIG. 5, the representative line acquisition unit 314 acquires a single representative line part L01 from the bundled part 910 of the wire assembly 9, as indicated in the image 56. Additionally, the representative line acquisition unit 314 extracts provisional representative lines (provisional representative lines L11, L12, L13, and L14) from the wires included in the loose wire part 911, and acquires a single representative line representing those provisional representative lines. As one example, the representative line acquisition unit 314 acquires a single center line passing through the center of the provisional representative lines L11 to L14 in a three-dimensional space as a representative line part L02.

Note that whether or not the provisional representative lines L11 to L14 correspond to the respective wires in the loose wire part 911 may be determined, for example, by detecting other provisional representative lines within a defined radial distance from a specific provisional representative line among the provisional representative lines L11 to L14. As one example, in the case where other provisional representative lines are present within a defined radial distance from a specific provisional representative line, the representative line acquisition unit 314 acquires a center line passing through the center of a three-dimensional space of the specific provisional representative line and the other provisional representative lines as a new provisional representative line. The representative line acquisition unit 314 then detects other provisional representative lines within the defined radial distance from the new provisional representative line, and in the case where such provisional representative lines are present, acquires a center line of the new provisional representative line and the other provisional representative lines as a new provisional representative line. This processing is repeated until the representative line acquisition unit 314 no longer detects another provisional representative line within the defined range. As a result, the representative line acquisition unit 314 can recognize a plurality of wires within a set range as the single loose wire part 911 and replace the loose wire part 911 with a single representative line.

Additionally, when acquiring a single representative line from the provisional representative lines L11 to L14, for example, it is also conceivable to acquire a single representative line from some of those provisional representative lines. For example, it is conceivable to identify the one innermost provisional representative line and take that provisional representative line as the single representative line indicating the loose wire part 911. Alternatively, it is conceivable to identify a center line from two or more of the provisional representative lines on the inner side of the provisional representative lines L11 to L14, and acquire a single representative line from those provisional representative lines.

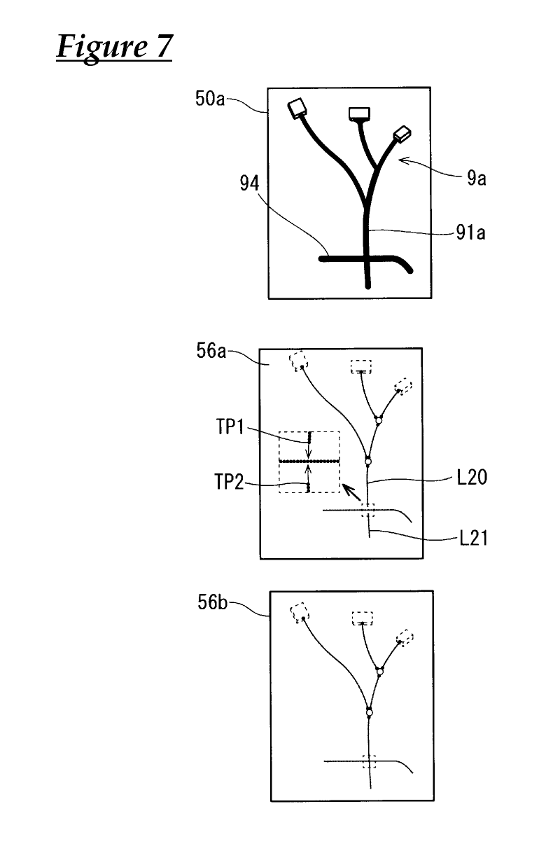

Returning to FIG. 4, once the representative line acquisition step S40 is finished, the hidden line acquisition unit 315 connects two end parts, of the end parts of the plurality of representative lines acquired by the representative line acquisition unit 314, that are located within a predetermined distance (a hidden line acquisition step S50). The hidden line acquisition step S50 will be described in detail with reference to FIG. 7.

FIG. 7 is a diagram illustrating the hidden line acquisition step S50. An image 50a illustrated in FIG. 7 is an image acquired by the image acquisition unit 311. In this example, another member 94 overlaps with a linear part 91a of a wire assembly 9a, and thus the linear part 91a is a hidden line. Thus as indicated in an image 56a, the representative line, of the representative lines acquired by the representative line acquisition unit 314, that corresponds to the linear part 91a is divided into a representative line part L20 and a representative line part L21.

Of all end points of the representative lines, the hidden line acquisition unit 315 identifies two end points within a predetermined distance, and extends the respective representative line parts from those two end points in a tangential direction. The space between the two end points is connected as a result. For example, assuming that end points TP1 and TP2 of the representative line parts L20 and L21 illustrated in FIG. 7 are within the predetermined distance, the representative line parts L20 and L21 are extended from the end points TP1 and TP2, respectively, in the tangential direction thereof, and connected. As a result, the hidden line produced by the other member 94 overlapping with the linear part 91a is supplemented as indicated by an image 56b.

Returning to FIG. 4, once the hidden line acquisition step S50 is finished, the loose wire part 911 is bundled such that the respective wires therein follow the representative line supplemented for the hidden line (a bundling step S51). A wire bundle is formed from the wire assembly 9 as a result. Note that in the case where there is no loose wire part 911 in the wire assembly 9, the bundling step S51 is skipped.

Once the wire bundle has been formed, the processing position identification unit 316 identifies a processing position in the wire bundle (a processing position identification step S60). In the processing position identification step S60, branch point identification is carried out first. An example of a branch point identification method will be described here. For example, as indicated by the image 56 in FIG. 5, the representative line L1 expressing the linear part 91 of the wire assembly 9 is acquired, and terminals TP11 and TP12 of the representative line L1 are identified. The terminals TP11 and TP12 correspond to terminal parts of the linear parts to be connected to the connectors 93. The representative line parts L01 and L02 corresponding to the linear parts are followed from the terminals TP11 and TP12, respectively, and points where those representative line parts merge with other representative line parts are taken as branch points. For example, when the representative line part L01 is followed from the terminal TP11, the representative line part L01 merges with the other representative line part L02. This point of merger is thus identified as a branch point DP1. Note that by furthermore following a representative line part L03 from the branch point DP1, the point where the representative line part L03 merges with another representative line part is also identified as a branch point. All of the branch points on the representative line L1 are identified in this manner.

Once the branch points have been identified, the processing position identification unit 316 measures the lengths along the representative lines extending from the branch points, and identifies the processing positions. Here, the processing positions in the wire bundle are saved in the storage unit 34 or the like in advance as design data. Specifically, the lengths from each branch point to the other branch points in the wire bundle, or the lengths of the linear part 91 to the terminals, are defined in the design data. For example, in the case of design data of the wire bundle illustrated in FIG. 5, the lengths from the branch point DP1 to the terminals TP11 and TP12 are defined in the design data.

Additionally, each processing position in the linear part 91 is defined by the length from the branch point (or the terminal) in the design data. By referring to the design data, the processing position identification unit 316 identifies the representative line parts to be processed, and identifies the processing positions in those representative line parts by measuring the lengths from the branch points (or terminals) along those representative line parts.

Meanwhile, the image processing apparatus 30 may be configured such that in the processing position identification step S60, the information of the branch points registered in the design data is verified against the information of branch points obtained through actual three-dimensional measurement in order to determine whether or not the acquisition of the hidden lines executed in the hidden line acquisition step S50 was correct. The image processing apparatus 30 may also be configured such that whether or not the other member that produces the break in the representative line part is another linear part 91 in the wire bundle can be estimated by verifying the branch point information.

Additionally, the image processing apparatus 30 can acquire hidden lines not identified in the aforementioned hidden line acquisition step by verifying information of the branch points actually identified by the processing position identification unit 316 against information of the branch points defined in advance in the design data.

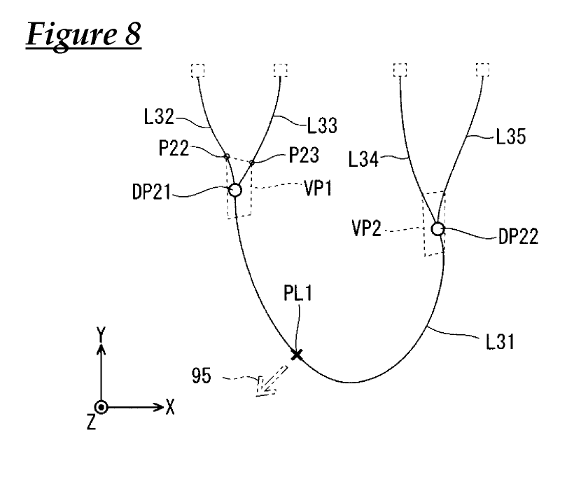

Returning to FIG. 4, once the processing position identification step S60 is finished, the orientation identification unit 317 identifies an attachment orientation of a member, such as a clamp, that has a predefined attachment orientation with respect to the wire bundle (an orientation identification step S70). The orientation identification step S70 will be described with reference to FIG. 8.

FIG. 8 is a diagram illustrating the orientation identification step S70. Of the branch points identified by the processing position identification unit 316, the orientation identification unit 317 takes two branch points connected by a single representative line, and for each of those branch points, acquires two virtual planes formed by a plurality of representative lines extending from the two branch points. Then, the orientation identification unit 317 acquires a twist of the representative line connecting the two branch points on the basis of the angle formed by the two virtual planes. The orientation identification unit 317 identifies the attachment orientation of the member to be attached in accordance with the twist in the representative line part.

For example, assume a case such as that illustrated in FIG. 8, in which representative line parts L31 to L35 expressing the linear part 91 of the wire bundle and branch points DP21 and DP22 have already been identified, and a clamp 95 is to be attached at a processing position PL1 in the representative line part L31. In this case, at each of the branch points DP21 and DP22 connected by the representative line part L31, the orientation identification unit 317 acquires virtual planes VP1 and VP2 formed by a plurality of representative line parts extending from each of those branch points (representative line parts L31, L32, and L33, and representative line parts L31, L34, and L35). Note that with respect to the virtual planes VP1 and VP2, for example, in the case of the branch point DP21, a plane passing through points that are a set distance from the branch point DP21 on the representative line parts L31, L32, and L33 (P21, P22, and P23, for example), is taken as the virtual plane VP1. The same applies for the virtual plane VP2.

Next, the orientation identification unit 317 acquires the angle formed by the virtual planes VP1 and VP2, and the attachment orientation of the clamp 95 is identified on the basis of that angle. In the case where the angle of the virtual plane VP2 to the virtual plane VP1 differs from a reference angle pre-set in the design data, it is estimated that the representative line part L31 is twisted more than expected. Accordingly, the attachment orientation of the clamp 95 may be tilted by an amount equivalent to this twisting. For example, assume that the actual angle of the virtual plane VP2 to the virtual plane VP1 and the reference angle differ by a degrees around the X axis and β degrees around the Y axis. Additionally, assume that the ratio of a length from the branch point DP21 to the processing position PL1, relative to a length from the branch point DP21 to the branch point DP22 (that is, a length of the representative line part L31), is R1. In this case, the attachment orientation of the clamp 95 may be tilted from a reference orientation around the X axis and the Y axis by angles obtained by multiplying α and β by R1.

As described thus far, once the processing positions are identified, or the attachment orientations of the members are identified, a robot (not illustrated) carries out various types of processes (bundling through taping or attaching a band, attaching clamps, attaching protective members such as tubes, and so on) at the identified processing positions in the wire bundle. A worker may instead carry out such processing tasks on the identified processing positions as appropriate. In this manner, a wire harness is manufactured from an unprocessed wire assembly 9 according to the design data.

According to the present embodiment, the three-dimensional shape of the wire assembly 9 can be measured with ease, and the processing positions can be identified with a high level of precision, by extracting representative lines expressing linear parts of the wire assembly 9.

### <2. Variation>

Although an embodiment has been described thus far, the present invention is not intended to be limited thereto, and many variations can be carried out thereon.

For example, the background removal unit 313 illustrated in FIG. 3 and the background removal step S30 illustrated in FIG. 4 can be omitted. In other words, suitable representative lines can be extracted from point group data having the point group data of the background. However, removing the point group data of the background from the point group data does make it possible to drastically reduce the processing load on the image processing apparatus 30. This in turn makes it possible to process the images quickly.

While the method has been described in detail, the foregoing descriptions are in all ways exemplary, and the invention is not intended to be limited thereto. It is to be understood that countless variations not described here can be conceived of without departing from the scope of the invention. Furthermore, the configurations described in the above embodiment and variation can be combined as appropriate as long as the configurations do not conflict with each other, and can furthermore be omitted.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

1 Measurement apparatus
10 Stage
20 Image capturing unit
21 Laser beam emission unit
23 Camera
30 Image processing apparatus
31 CPU
311 Image acquisition unit
312 Point group data acquisition unit
313 Background removal unit
314 Representative line acquisition unit
315 Hidden line acquisition unit
316 Processing position identification unit
317 Orientation identification unit
34 Storage unit
9, 9c Wire bundle
91, 91a to 91c Linear part
93 Connector
95 Clamp (member)
DP1 to DP3 Branch point
DP21, DP22 Branch point
L1 Representative line
L01 to L05 Representative line part
L10, L11 Representative line part
L21 to L25 Representative line part
L31 Representative line part
P1 to P9 Point
PG1 Program
PL1 Processing position
S10 Image acquisition step
S20 Point group data acquisition step
S30 Background removal step
S40 Representative line acquisition step
S50 Hidden line acquisition step
S60 Processing position identification step
S70 Orientation identification step
TP1, TP2 End point
TP11 to TP13 Terminal
VP1, VP2 Virtual plane

1. A method of manufacturing a wire harness, the method comprising:
a point group data acquisition step of acquiring point group data from image data acquired by capturing an image of a wire assembly using an image capturing unit;
a representative line acquisition step of acquiring a representative line indicating a linear part of the wire assembly on the basis of the point group data; and
a processing position identification step of identifying a processing position on the wire assembly to be processed, on the basis of a length along the representative line.

2. The method of manufacturing a wire harness according to claim 1,
wherein the processing position identification step includes a step of identifying a branch point where the representative line branches, and identifying the processing position on the basis of a length from the identified branch point along the representative line.

3. The method of manufacturing a wire harness according to claim 2, further comprising:
an orientation identification step of acquiring, for two of the branch points connected by a representative line part that is a part of the representative line, two virtual planes formed by a plurality of representative line parts extending from the two branch points, and identifying an orientation of a member to be attached to the representative line connecting the two branch points on the basis of an angle formed by the two virtual planes.

4. The method of manufacturing a wire harness according to claim 1,
wherein the representative line acquisition step is a step of identifying a group of center points of a linear part of the wire assembly on the basis of the point group data and using a line connecting that group of center points as the representative line.

5. The method of manufacturing a wire harness according to claim 4,
wherein the group of center points is a collection of center points, of a point group located on a contour of the wire assembly expressed by the point group data, that are in the center with respect to two directions orthogonal to a depth direction.

6. The method of manufacturing a wire harness according to claim 1, further comprising:
a background removal step of removing, from the point group data acquired in the point group data acquisition step, background point group data obtained by capturing an image of a background without the wire assembly using the image capturing unit,
wherein the representative line acquisition step is a step of acquiring the representative line on the basis of point group data from which the background point group data has been removed.

7. The method of manufacturing a wire harness according to claim 1, further comprising:
a hidden line acquisition step of connecting two end parts, among end parts of the representative line acquired in the representative line acquisition step, that are within a predetermined distance.

8. The method of manufacturing a wire harness according to claim 1,
wherein the image capturing unit detects phase differences between laser light emitted onto points of the wire assembly and laser light reflected by those respective points using a plurality of two-dimensional detectors.

9. An image processing method comprising:
a point group data acquisition step of acquiring point group data from image data acquired by capturing an image of a wire assembly using an image capturing unit;
a representative line acquisition step of acquiring a representative line indicating the wire assembly on the basis of the point group data; and
a processing position identification step of identifying a processing position on the wire assembly to be processed, on the basis of a length along the representative line.
